(19) United States
(12) Patent Application Publication
(10) Pub. No.: US 2005/0135371 A1
(43) Pub. Date: Jun. 23, 2005

(54) Method and system for selecting a switching port of a subscriber matching unit

(75) Inventor: Ki-Taek Kim, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/020,790

(22) Filed: Dec. 22, 2004

(30) Foreign Application Priority Data
Dec. 22, 2003 (KR) 10-2003-0094934

(51) Int. Cl. H04L 12/56

(52) U.S. Cl. 370/395.1

(57) ABSTRACT

A method and a system for selecting a switching port of a subscriber matching unit is disclosed. The method comprises transmitting data from a switching module through the switching port, receiving the data at the subscriber matching unit, detecting a switching port number of the subscriber matching unit from the received data, and setting during an initialization process of the subscriber matching unit the switching port number in response to a detected switching port number.

### CROSS-REFERENCE TO RELATED APPLICATIONS

Pursuant to 35 U.S.C. § 119(a), this application claims the benefit of earlier filing date and right of priority to Korean Application No. 10-2003-0094934 filed on Dec. 22, 2003, contents of which are hereby incorporated by reference herein in its entirety.

### BACKGROUND OF THE INVENTION

1. Field of the Invention

The present invention relates to a method and system for selecting a switching port of a subscriber matching unit.

2. Description of the Related Art

An asynchronous transfer mode (ATM) is a transmission and switching technique which is a core part of a B-IDSN. The ATM was determined as a transmission mode of Broadband IDSN (B-IDSN) in an ITU-U (CCIT) in 1988.

The ATM is a dedicated-connection switching technique that processes information into blocks having a fixed length called an ATM cell. A destination address is added before processing the received information. The processed information is sequentially transmitted. The ATM switching system may exchange and/or transmit, on a real time basis, various types of information at a low to a high speed.

FIG. 1 illustrates a model of a conventional ATM switching system. The ATM switching system provides a main controller 10 for operating and managing a switching system, subscriber matching units 30, such as 1, 2, 3, . . . , n, for matching a switching module 20 and a subscriber terminal unit (not shown). The ATM transmits data from the subscriber matching units 30 to a destination subscriber matching unit.

FIG. 2 is a flow chart illustrating operation of the conventional subscriber matching unit of FIG. 1.

Power is supplied to each of the subscriber matching units 30 of the ATM switching system (S10). Each of the subscriber matching units 30 initializes internal elements (S20). Hardware of the switching module 20 recognizes a previous physical setting of a switching port number to determine the switching port number (S30). Each of the subscriber matching units 30 selects an inter-process communication (IPC) with a main controller 10.

The main controller 10 monitors states of the subscriber matching units 30 and the switching module 20 utilizing the IPC for controlling set-up and release of connections between the switching module 20 and the subscriber matching units 30.

The subscriber matching units 30 receive data from an external subscriber terminal unit not shown. The subscriber matching units 30 process received data in accordance to an instruction from the main controller 10 for creating processed data. The main controller 10 adds a number identifying the destination subscriber matching unit of the processed data. The subscriber matching units 30 transfer the processed data to the switching module 20.

The switching module 20 transfers the processed data to the destination or external subscriber terminal unit (not shown) in a similar manner as that described above.

The ATM switching system separates the received data into rack, shelf, and slot units. The subscriber matching units 30 and the switching module 20 are mounted in the ATM switching system in accordance to slot units.

The subscriber matching units 30 and the switching module 20 are electrically connected by cable. If an error occurs while specifying a slot unit, the subscriber matching units 30 switch the cable to another slot unit.

The conventional art has problems during initialization of the subscriber matching units 30. During initialization, a switching port number for each of the subscriber matching units 30 is selected and physically fixed. An error may occur in the specified slot unit, even if newly set, causing the subscriber matching units 30 to recognize a prior physical designated switch port as the switching port.

The error interrupts switching between the switching module 20 and the subscriber matching units 30, which also causes errors in a data exchange function of the subscriber matching units 30. The data exchange function is a critical component for a switching system.

Therefore, there is a need for a method and system that overcomes the above problems and provides advantages over other switching ports.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one embodiment, a method comprises transmitting data from a switching module through the switching port, receiving the data at the subscriber matching unit, detecting a switching port number of the subscriber matching unit from the received data, and setting during an initialization process of the subscriber matching unit the switching port number in response to a detected switching port number. The switching system preferably is an asynchronous transfer mode switching system.

The method may further comprise generating data associated with the subscriber matching unit. The method may further comprise transmitting the generated data through each switching port in accordance with a number of switching ports.

In another embodiment, a system for selecting a switching port of a subscriber matching unit for a switching system is disclosed. The system comprises a switching module for transmitting data through the switching port, the subscriber matching unit for receiving the data, and a detector for detecting the switching port number of the subscriber matching unit from the received data. The subscriber matching unit sets during an initialization process the switching port number in response to the detected switching port number.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

FIG. 1 illustrates a model of a conventional ATM switching system.

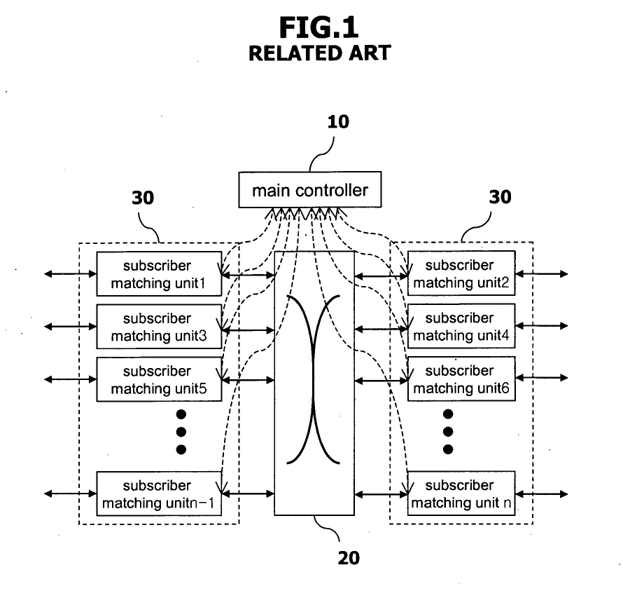

FIG. 2 is a flow chart for conventional operation of a subscriber matching unit.

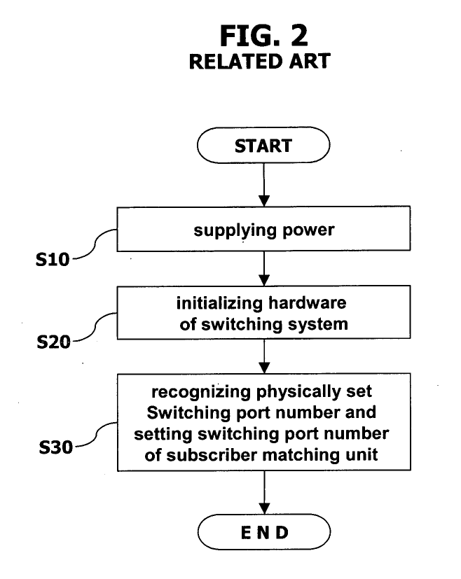

FIG. 3 is a flow chart illustrating operational aspects of a switching system in accordance with a preferred embodiment of the present invention.

FIG. 4 is a flow chart illustrating initialization of the subscriber matching unit of FIG. 3.

FIG. 5 is a flow chart of a search data transmission procedure in accordance with the preferred embodiment of the present invention.

FIG. 6 is a flow chart of a search data reception procedure in accordance with the preferred embodiment of the present invention.

FIG. 7 is a schematic diagram of an MSR40 switching system adopting a switching port selection in accordance with the preferred embodiment of the present invention.

FIG. 8 is a detailed block diagram of the subscriber matching unit of FIG. 7.

### DETAILED DESCRIPTION OF THE PREFERRED EMBODIMENTS

The invention adaptively selects a switching port number using a subscriber matching unit during an initialization process. During the initialization process, the subscriber matching unit establishes, though an operating system or an application program, a switching port for communicating signals.

Although the invention is illustrated with respect to a subscriber matching unit for an asynchronous transfer mode (ATM) switching system, it is contemplated that the invention may be utilized anywhere it is desired for providing accurate switching of signaling ports within a mobile communication system. Reference will now be made in detail to the preferred embodiments of the present invention, examples of which are illustrated in the accompanying drawings.

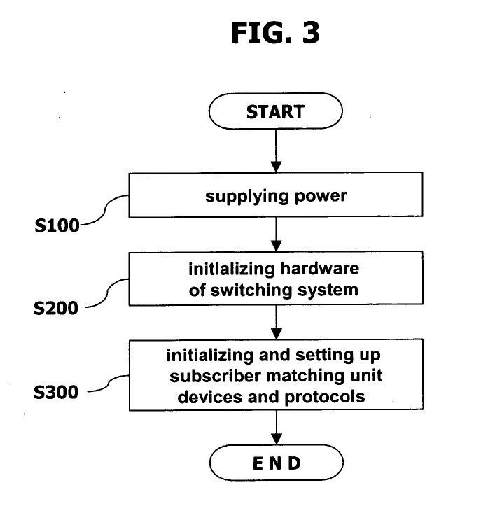

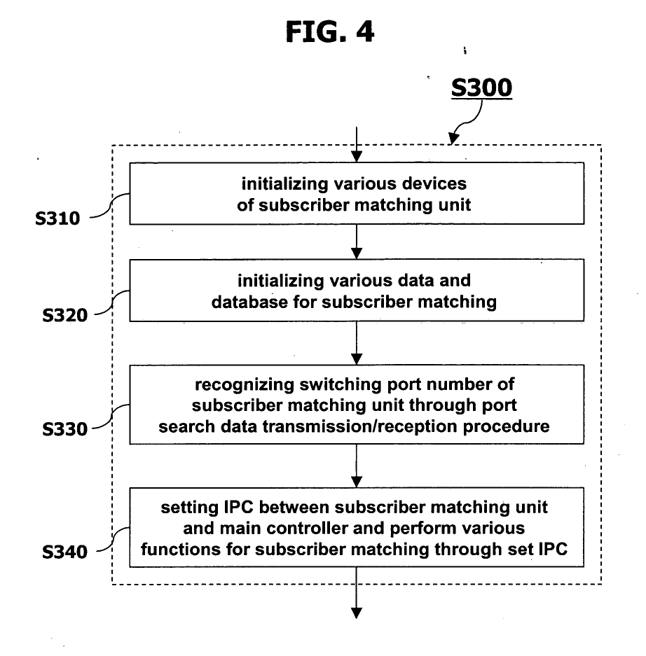

FIGS. 3 and 4 are flow charts depicting operational aspects of a switching system and a subscriber matching unit in accordance with the present invention.

When power is supplied to a subscriber matching unit, the subscriber matching unit initializes internal elements, drives an operating system and/or an application program.

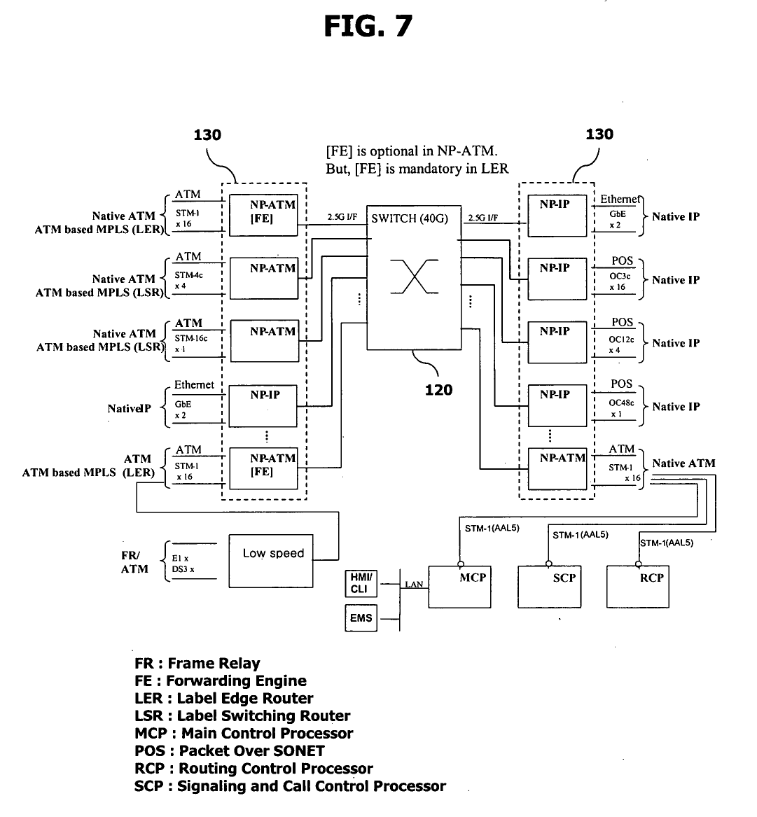

The subscriber matching unit 130, as shown in FIG. 7, initializes an application program and a database for matching of the subscriber matching unit 130 and other devices (S310 and S320). The subscriber matching unit 130 performs a data transmission or reception procedure for recognizing a switching port (S330).

The main controller 110 and the IPC are set. The subscriber matching unit 130 through the set IPC performs numerous functions for matching between a subscriber matching unit 130 and a switching module 120, as shown in FIG. 7 (S340).

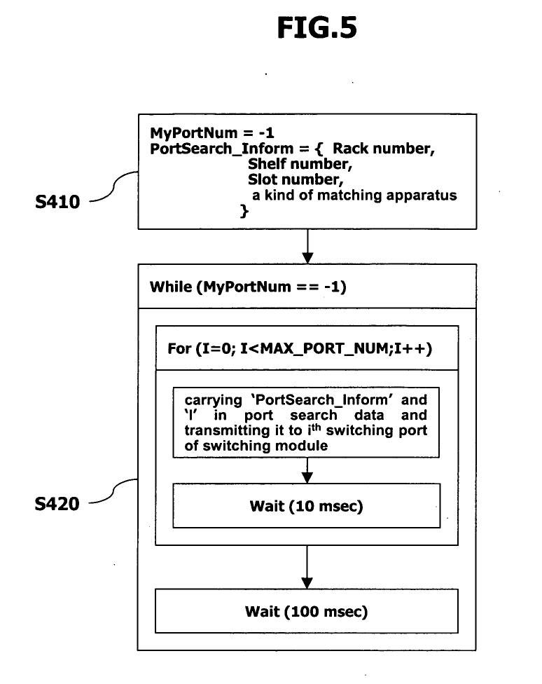

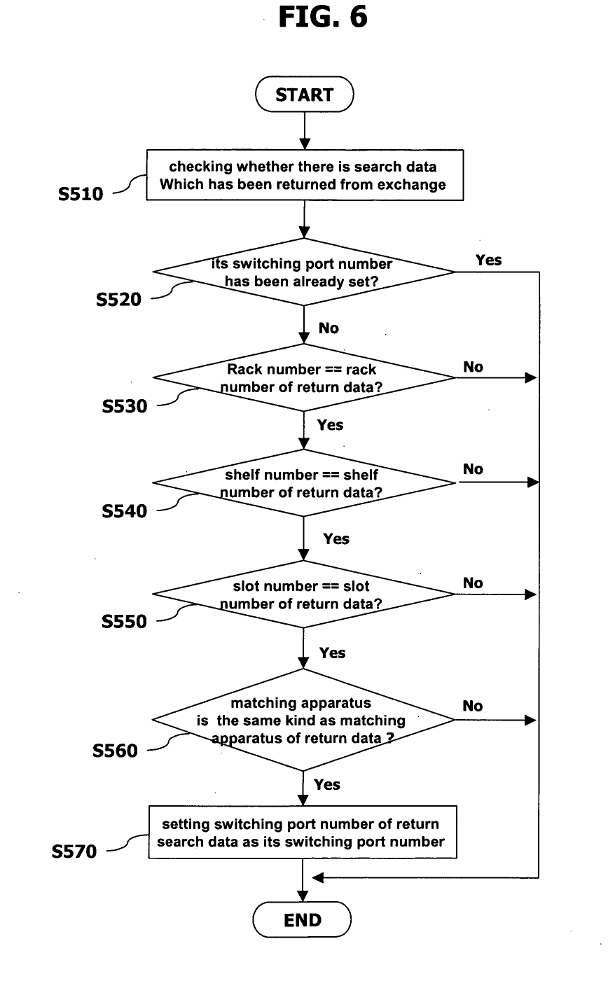

The process of recognizing a switching port by the subscriber matching unit 130 will now be described in detail with reference to FIGS. 5 and 6.

The switching port 120, as shown in FIG. 7, recognizes the process (S330) including such tasks as performing a transmission procedure for searching data (steps S410-S420) and a data receiving procedure for searching data (S510-S570).

The search data transmission procedure (S410-S420) is explained below.

The subscriber matching unit 130 allocates an initial value (−1) to a switching port number to indicate the switching port number has not been determined. The subscriber matching unit 130 generates port search data, such as PotSearch_Inform, and subscriber information (S410). The subscriber information, for example, may be divided into categories such as a rack number, a shelf number, a slot number, and information defining type of subscriber matching unit. The content of the subscriber information may differ depending on elements that comprise the switching module 120.

The subscriber matching unit 130 transmits port search data through each of the switching ports, for example from the lowest number to the highest number switching port, to the switching module (S420). When the port search data is transmitted, the corresponding switching port number is transmitted.

While the search data transmission procedure (S410 and S420) is performed, the subscriber matching units 130 perform a port search data receiving procedure (S510-S570).

The subscriber matching unit 130 determines if the port search data has been received from the switching module 120 (S510). If the port search data has been received, the subscriber matching unit, for example, through the switching port set function ‘MyPortNum’ determines if the switching port number has been set (S520). If a switching port number has not been set, for example if MyPortNum=−1, the subscriber matching unit compares received port search information, such as the rack number, the shelf number, the slot number and a type of a subscriber unit, with the receiving switching port information (S530-S560).

If the received port search and the receiving switching port information are identical, the subscriber matching unit detects the switching port number from the port search data as the switching port (S570), and stops the search data transmission procedure (S410 and S420).

FIG. 7 is a schematic diagram of an MSR40 switching system in accordance with the preferred embodiment of the present invention.

The MSR40 switching system comprises a switching module 120 having a process rate of 40 Giga bps, and a subscriber matching unit 130 performing ATM matching on the basis of Multi Protocol Label Switching (MPLS). The MPLS may be, for example, a Network Processor and Asynchronous Transfer Mode (NP-ATM) or a Network Processor & Internet Protocol (NP-IP).

The subscriber matching units 130 directly connect to the switching module 120 and are allocated a switching port number in accordance with connection points. The subscriber matching unit 130 may be connected to any other switching port of the switching module.

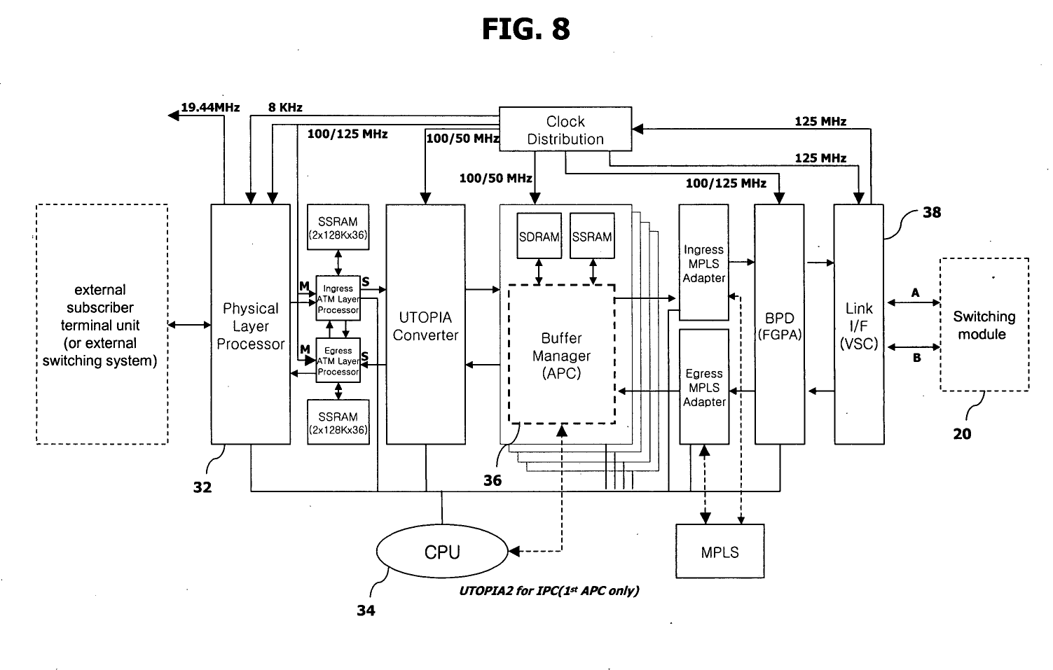

FIG. 8 is a detailed block diagram of the subscriber matching unit 130 of FIG. 7.

The subscriber matching unit 130 provides a physical layer processor 132 connected to an external switching system or external subscriber terminal unit using an optical cable, an link I/F 138 is matched to the switching module 120, and a central processing unit (CPU) 134 generates a data port search. The data port search provides, for example, switching port information such as rack number, shelf number, slot number and a type of a subscriber unit, etc . . . of the subscriber matching unit 130.

An automatic port controller (APC) 136 receives port search data from the CPU 134 and transmitting it to each switching port. The APC 136 transmits the port search data to each switching port during specified time intervals. Transmission of the port search data is repeated until the switching port number of the subscribermatching unit is determined.

The present invention provides for adaptively setting a switching port number of a subscriber matching unit during the initialization process which prevents a physical error of the subscriber matching unit upon repositioning of a transmission line. The present invention by preventing error in the subscriber matching unit designation enhances reliability and stability of the ATM switching system.

Although the present invention is described in the context of a subscriber matching units for matching a switching module and a subscriber terminal, the present invention may also be used in any wired or wireless communication systems using mobile devices, such as PDAs and laptop computers equipped with wired and wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

The foregoing embodiments and advantages are merely exemplary and are not to be construed as limiting the present invention. The present teaching can be readily applied to other types of systems. The description of the present invention is intended to be illustrative, and not to limit the scope of the claims. Many alternatives, modifications, and variations will be apparent to those skilled in the art. Accordingly, the invention is not limited to the precise embodiments described in detail hereinabove.

1. A method of selecting a switching port of a subscriber matching unit for a switching system, the method comprising:
transmitting data from a switching module through the switching port;
receiving the data at the subscriber matching unit;
detecting a switching port number of the subscriber matching unit from the received data; and
setting during an initialization process of the subscriber matching unit the switching port number in response to a detected switching port number.

2. The method of claim 1, wherein the switching system is an asynchronous transfer mode switching system.

3. The method of claim 1, further comprising generating data associated with the subscriber matching unit.

4. The method of claim 3, further comprising transmitting the generated data through each switching port in accordance with a number of switching ports.

5. The method of claim 1, wherein the data comprises subscriber matching unit information and a number of a switching ports which manage transmission of the data.

6. The method of claim 1, wherein receiving the data at the subscriber matching unit further comprises receiving specific information of the subscriber matching unit.

7. The method of claim 6, wherein the specific information comprises at least one of rack number, a shelf number, a slot number, and type of the subscriber matching unit.

8. The method of claim 1, further comprises:
determining if subscriber information has been received in the received data from the switching module; and
comparing the received data to the subscriber information associated with the subscriber matching unit.

9. The method of claim 1, further comprising:
determining if subscriber information extracted from the received data equals a subscriber information; and
assigning a switching port number based on the received data if the received data equals the subscriber information.

10. A method for selecting a switching port of a subscriber matching unit of a switching system, the method comprising:
supplying power to the subscriber matching unit;
initializing internal circuits of the subscriber matching unit;
driving an operating system of the subscriber matching unit for recognizing the switching port of the subscriber matching unit; and
selecting a recognized switching port as the switching port of the subscriber matching unit.

11. The method of claim 10, wherein selecting the recognized switching port comprises:
generating data including specific information for the subscriber matching unit;
transmitting the generated data to a switching module through the switching port; and
designating a return data port as the switching port of the subscriber matching unit upon reception by the switching port of a portion of a received data information.

12. The method of claim 10, wherein selecting the recognized switching port comprises:
determining whether data has been received from a switching module;
comparing subscriber matching unit information to received data information;
detecting a switching port number of the received data information; and
selecting a switch port number from the received data information as the subscriber port number if the subscriber matching unit information is identical to the received data information.

13. The method of claim 11, wherein the specific information comprises the subscriber matching unit and the number of a switching ports managing data transmission.

14. The method of claim 11, wherein the specific information comprises at least one of a rack number, a shelf number, a slot number and information on type of a subscriber matching unit.

15. The method of claim 11, wherein the switching system is an asynchronous transfer mode switching system.

16. A system for selecting a switching port of a subscriber matching unit for a switching system, the system comprising:
a switching module for transmitting data through the switching port to the subscriber matching unit for receiving data; and
a detector for detecting a switching port number of the subscriber matching unit from the received data during an initialization process in response to the detected switching port number.

17. The system of claim 16, wherein the switching system is an asynchronous transfer mode switching system.

18. The system of claim 16, wherein the switching system generates data associated with the subscriber matching unit.

19. The system of claim 18, wherein the switching system transmits the generated data through each switching port in accordance with a number of switching ports.

20. The system of claim 18, wherein the generated data comprises subscriber matching unit information and a number of a switching ports which manage transmission of the received data.
